(19) United States
(12) Patent Application Publication
(10) Pub. No.: US 2010/0007324 A1
(43) Pub. Date: Jan. 14, 2010

(54) VOLTAGE REFERENCE ELECTRONIC CIRCUIT

(75) Inventors: Thierry Masson, Varces (FR); Jean-Francois Debroux, St. Etienne St. Geoirs (FR); Pierre Coquille, Saint Theoffrey (FR)

Correspondence Address: LOWE HAUPTMAN HAM & BERNER, LLP, 1700 DIAGONAL ROAD, SUITE 300, ALEXANDRIA, VA, 22314, US

(73) Assignee: E2V SEMICONDUCTORS, SAINT EGREVE (FR)

(21) Appl. No.: 12/444,252

(22) PCT Filed: Oct. 5, 2007
(86) PCT No.: PCT/EP2007/060624

§ 371 Date: May 27, 2009

(30) Foreign Application Priority Data
Oct. 6, 2006 (FR) 0608789

(51) Int. Cl. G05F 3/30

(52) U.S. Cl. 323/313

(57) ABSTRACT

The invention relates to a temperature-independent voltage reference circuit. The circuit comprises a first circuit of bandgap type providing a first-order temperature-stable voltage, on the basis of a bipolar transistor base-emitter voltage having a negative slope of variation as a function of temperature, and of a voltage or a current having a positive slope of variation as a function of temperature provided by a generator of current proportional to absolute temperature. The base currents of the PMOS transistors thereof are compensated in such a manner that the output current is proportional to a collector current and not an emitter current. A summator establishes a linear combination, with respective weighting coefficients, of three voltages which are respectively the output voltage of the first circuit, the output voltage of a second circuit providing a voltage proportional to the difference between the absolute temperature T and a reference temperature Tr, and the output voltage of a third circuit providing a voltage proportional to the square of this difference.

### CROSS-REFERENCE TO RELATED APPLICATIONS

The present Application is based on International Application No. PCT/EP2007/060624, filed on Oct. 5, 2007, which in turn corresponds to French Application No. 0608789 filed on Oct. 6, 2006, and priority is hereby claimed under 35 USC § 119 based on these applications. Each of these applications are hereby incorporated by reference in their entirety into the present application.

### FIELD OF THE INVENTION

The invention relates to electronic integrated circuits and more precisely it relates to the realization of a temperature-independent voltage reference circuit which relies on the properties of silicon bipolar transistors.

### BACKGROUND OF THE INVENTION

The establishment of a reference voltage in a silicon-based integrated circuit usually comprises the realization of a circuit generically called a “reference circuit of bandgap type” because of the fact that it uses intrinsic physical properties of silicon to ensure constancy of the voltage despite temperature variations; the term “bandgap” refers to the intrinsic energy difference which exists between the valence and conduction bands of the silicon, which difference is practically independent of temperature in a wide range of temperatures.

A reference circuit of bandgap type conventionally uses the combination of a base-emitter voltage of a transistor, which varies negatively (and almost linearly) with temperature, and of a current or voltage which varies positively (and almost linearly) with temperature. For example, the difference of the base-emitter voltages of two transistors of different emitter areas, diode-mounted and supplied by identical current sources, is a voltage which varies positively with temperature.

The result of this combination is however not perfect over a wide temperature range, notably a range from −50° C. to +120° C.: it is found that, even with compensation circuits and with the finest adjustments of the parameters of the circuit (transistor sizes, values of resistances, of currents, etc.), a curve of voltage variation which is almost flat near ambient temperatures but which is curved both for low temperatures and for high temperatures is obtained.

Examples of reference circuits of bandgap type with corrections of curvature as a function of temperature will be found in the literature, for example: “A curvature corrected low-voltage bandgap reference”, by Gunawan, Meijer, Fondrie, Huijsing in IEEE JSSC June 1993; or else “A new Fahrenheit temperature Sensor”, by R. Pease in IEEE JSSC December 1984. These corrections are complex.

The problem is made more critical for CMOS technology circuits, in which the bipolar transistors which are available for realizing the voltage reference circuit are PNP transistors of mediocre properties and whose characteristics are very dispersed from one circuit to another; these transistors are in fact mainly transistors that may be described as stray transistors constituted by the P-type substrate, N-type wells of the PMOS transistors and source diffusions of these PMOS transistors. Now, it is important to be able to achieve temperature-stable voltages even in CMOS technology circuits which have no other available bipolar transistors.

Generally, the obtaining of an accurate and reproducible reference voltage, stable over a wide range of temperatures (−50° C. to +120° C.), poses problems. The aim of the invention is to propose a solution which improves the performance of the earlier circuits.

### SUMMARY OF THE INVENTION

According to the invention, a voltage reference circuit is proposed, comprising a first circuit of bandgap type providing a first-order temperature-stable voltage or current, on the basis of a PTAT current generator providing a current proportional to absolute temperature, this generator comprising, between a power supply and a ground, two parallel branches, one comprising a first MOS transistor in series with a diode-mounted bipolar transistor, the other comprising a second MOS transistor identical to the first, a resistor and a second bipolar transistor having an emitter area N times as large as the emitter area of the first, with a differential amplifier which controls the MOS transistors and which establishes in the resistor a voltage drop equal to the difference of the base-emitter voltages of the two bipolar transistors, characterized in that there are provided means for injecting, at the junction point between the first bipolar transistor and the first MOS transistor, a current which is equal to the base current of the first bipolar transistor and means for injecting, at the junction point of the second bipolar transistor and of the second MOS transistor, a current which is equal to the base current of the second bipolar transistor, in such a manner that the output current of the generator of current proportional to temperature is equal to the collector current and not to the emitter current of a bipolar transistor.

The first circuit of bandgap type provides a first-order temperature-stable voltage or current on the basis
of a bipolar transistor base-emitter voltage having a negative slope of variation as a function of temperature
and of the current arising from the PTAT current generator (having a positive slope of variation as a function of temperature).

The voltage reference circuit preferably comprises a summator for establishing a linear combination, with respective weighting coefficients, of three values which are respectively
the output voltage or current of the first circuit of bandgap type,
the output voltage or current of a second circuit providing a voltage or a current proportional to the difference between the absolute temperature T and a reference temperature Tr,
the output voltage or current of a third circuit providing a voltage or a current proportional to the square of this difference.

Preferably, the first circuit of bandgap type comprises, in addition to the PTAT current generator providing a current proportional to absolute temperature, means for producing a current which is the ratio of a bipolar transistor base-emitter voltage to a resistance value, this current being applied to an input of an operational amplifier of the summator.

The circuit (termed a “thermometer” circuit) providing a voltage proportional to the difference (T−Tr) preferably comprises a generator of current proportional to absolute temperature (which can be the same as the previous), means for applying this current to a resistor and to a bipolar transistor, and a differential amplifier for establishing a voltage which is the difference between the base-emitter voltage of this bipolar transistor and the voltage drop across the terminals of the resistor.

The reference temperature is preferably the ambient temperature of about 25° C.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF DRAWINGS

The present invention is illustrated by way of example, and not by limitation, in the figures of the accompanying drawings, wherein elements having the same reference numeral designations represent like elements throughout and wherein:

FIG. 1 represents the basic principle of a circuit of PTAT type establishing a current proportional to absolute temperature, embodied in a CMOS technology and using the stray PNP transistors of this technology;

FIG. 2 represents the basic principle of a circuit of bandgap type based on the first-order equilibrium between the negative variation of a bipolar transistor base-emitter voltage and the positive variation of a PTAT-type circuit current;

FIG. 3 represents another exemplary embodiment of a circuit of bandgap type;

FIG. 4 represents the general architecture of a temperature-stable voltage reference circuit according to the invention;

FIG. 5 represents the use of a conventional circuit of bandgap type, in the architecture according to the invention;

FIG. 6 represents an exemplary embodiment of a circuit termed a “thermometer” circuit providing a voltage proportional to T−Tr;

FIG. 7 represents an exemplary embodiment of a circuit for squaring the output voltage of the thermometer circuit;

FIG. 8 represents a circuit layout making it possible to improve the behavior of the circuit by eliminating the harmful influence of the poor current gain of the PNP bipolar transistors used in the circuit when the latter is embodied in a purely CMOS technology.

### DESCRIPTION OF PREFERRED EMBODIMENTS

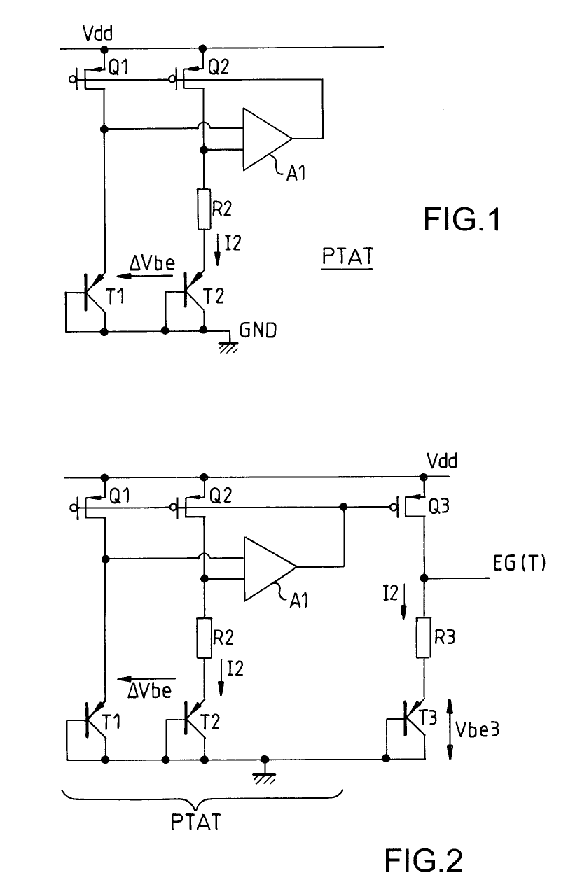

In FIG. 1, the PNP bipolar transistors T1 and T2 and the PMOS transistors Q1 and Q2 form together with a differential amplifier A1 the core of a PTAT current generator, that is to say a circuit providing a current proportional to absolute temperature T. The transistors T1 and T2 are of different emitter areas, the transistor T2 having an area N times greater than that of the transistor T1. The transistors Q1 and Q2 are identical and constitute variable but identical current sources. Their gates are brought to one and the same variable potential and their source is at a supply voltage Vdd. The transistor T1 is diode-mounted between the drain of Q1 and a ground GND: base and collector of T1 are joined and grounded, the emitter is linked to the drain of Q1. The arrangement is the same for T2 and Q2 but a resistor R2 is interposed between the drain of T2 and the emitter of Q2. The differential amplifier A1 has its two inputs linked respectively to the drains of Q1 and Q2; it effects a feedback by acting on the common potential of the gates of these two transistors, therefore on the identical currents which pass through them, until an equilibrium point is found where the potentials of the two drains are identical (to within the input offset voltage of the amplifier). The voltage drop R2.I2 in the resistor R2 then exactly compensates the difference ΔVbe between the base-emitter voltages of T1 and T2; now, it is known that this difference is proportional to the absolute temperature and to the Napierian logarithm of the ratio N between their emitter areas if the two transistors T1 and T2 are of the same technology and placed under the same temperature conditions; the equation is:

ΔVbe=(kT/q)Log N

k is Boltzmann's constant, q the charge on the electron, T the absolute temperature, N the ratio of the emitter areas.

From this it follows that the current I2 passing through the resistor R2 adjusts itself automatically to a value of the form

I2=(kT/q)(Log N)/R2 (for transistors having a sufficiently high current gain for the base current to be negligible compared with the collector current).

The circuit of FIG. 1 therefore constitutes a generator of current I2 of value proportional to the absolute temperature and varying linearly and positively with temperature.

On the basis of this current I2, with positive variation, and of a resistor R3, a voltage with positive variation R3.I2 can easily be realized, and a bipolar transistor base-emitter voltage which varies negatively with temperature can be added to the voltage R3.I2.

This addition of two voltages with inverse directions of variation is achieved for example by the circuit of FIG. 2: the left part of FIG. 2 exactly matches the circuit of FIG. 1 and constitutes a PTAT current generator. The current I2 is copied over by a PMOS transistor Q3 mounted as a current mirror of the transistors Q1 and Q2 (same source potential Vdd, same gate potential provided by the output of the amplifier A1). The transistor Q3 is preferably identical to the transistors Q1 and Q2 but this is not compulsory; if it is not identical to them, account must be taken thereof in the calculations.

A resistor R3 is linked between the drain of Q3 and the emitter of a PNP transistor T3 diode-mounted like T1 and T2, having its collector and its base grounded. The series assembly Q3, R3, T3 is therefore mounted like the assembly Q2, R2, T2 and the current which flows through the resistor R3 is identical to the current I2 which flows through R2.

The potential of the junction point of Q3 and R3 is therefore the sum of the base-emitter voltage Vbe3 of T3 and of the voltage drop R3.I2 of value R3.I2=(kT/q)(Log N)R3/R2. It will be noted that only the ratio of the resistances plays a role in the value of the voltage drop R3.I2, this ratio being practically independent of temperature. The coefficient of positive variation with temperature is (k/q)(Log N)R3/R2.

The negative variation of the base-emitter voltage Vbe3 of the transistor T3 depends on technological parameters of the transistor. It is linear to first order, and the order of magnitude of the coefficient of variation is for example −2 mV/° C. It can be determined experimentally for a given technology. Consequently, by correctly choosing the resistor R3 and by adding together the voltage R3.I2 and the voltage Vbe of the transistor T3, it is possible to obtain a voltage having an overall coefficient of variation which is zero to first order. The value chosen for R3 with this aim obviously depends on the values chosen for N and for R2 as well as on the emitter area of the transistor T3.

The circuit of FIG. 2 is a circuit that may be called a “bandgap circuit core” and the voltage EG(T)=R3(kT/q)(Log N)/R2+Vbe3 which appears between the output of this circuit and ground is a voltage which, to first order, is independent of temperature.

Nevertheless, there are second- or third-order effects which imply that the voltage EG(T) exhibits a certain manufacturing dispersion and is not completely constant with temperature; this is all the more true the poorer the quality of the PNP transistors. Now, in many MOS technology circuits, only PNP transistors of poor quality are available (transistors with low beta, that is to say with low current gain). The input offset voltage of the differential amplifier A1 is also a factor which impairs the constancy of the output voltage EG(T).

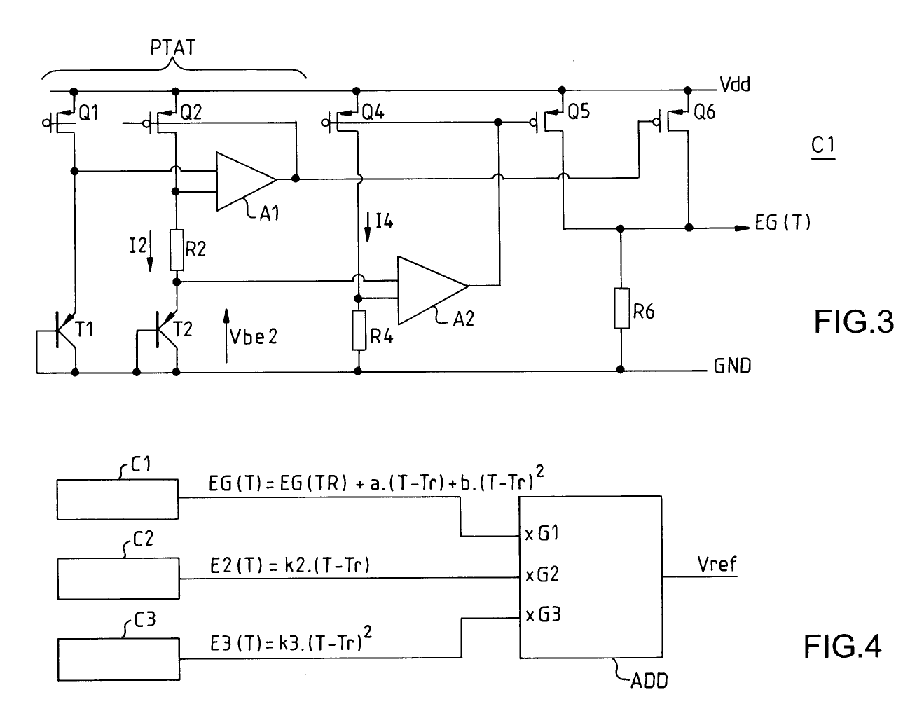

Another exemplary embodiment is shown in FIG. 3; this circuit operates in a very similar manner to that of FIG. 2 and it is presented here since it is easier to use in the architecture of the present invention. In this example, instead of adding together two voltages Vbe3 and R3.I2 in a branch Q3, R3, T3 as was the case in FIG. 2, two currents are added together before the sum of these currents is converted into a voltage EG(T). A very similar result is obtained in terms of addition of voltages one of which varies positively and the other negatively. The elements identical to those of FIG. 2 bear the same references and play the same role; this mainly involves the PTAT generator which establishes a current I2=(kT/q)(Log N)/R2 on the basis of the transistors T1 and T2 of different emitter areas.

A differential amplifier A2 controls the gate of a PMOS transistor Q4 which is in series with a resistor R4, so as to pass a current through the resistor R4 such that the voltage drop in this resistor is equal to the base-emitter voltage Vbe2 of the transistor T2. For this purpose, the differential amplifier A2, with large gain, receives the difference between the voltage across the terminals of R4 and the base-emitter voltage Vbe2; the current in the transistor Q4 adjusts itself automatically to a value I4 such that R4.I4=Vbe2. This arrangement therefore converts the voltage Vbe2 into a current Vbe2/R4 in the resistor R4 and in the transistor Q4. A PMOS transistor Q5 copies over the current Vbe2/R4 which passes through Q4 (same gate voltage as Q4, same source voltage Vdd); another PMOS transistor Q6 copies over the current I2 which passes through the transistor Q2 (same gate voltage as Q2, same source voltage Vdd). The currents of Q5 and Q6, respectively equal to Vbe2/R4 and I2=(kT/q)(Log N)/R2 are added together in a load resistor R6. In the layout of FIG. 3, the load resistor is linked between, on the one hand, the joined drains of Q5 and Q6 and, on the other hand, ground. It will be seen that the load resistor can also be an input resistor or a looping resistor of an operational amplifier.

The output voltage EG(T) across the terminals of the resistor R6 is then: EG(T)=R6.(kT/q)(Log N)/R2+Vbe2.R6/R4. The result is therefore substantially identical to that afforded by the layout of FIG. 2.

FIG. 8 represents the principle of the present invention.

As has been stated, the PNP transistors may be of poor quality and notably they may have a highly dispersed, low beta current gain. This is the case in particular when the voltage reference circuit is embodied in a CMOS technology where the only bipolar transistors available are PNP transistors formed between the P-type substrate, the N-type wells and the source and drain diffusions of the PMOSs formed in these wells. These transistors are of poor quality. This is why it is preferable to provide a circuit for compensating the PTAT current generator, which will be described with reference to FIG. 8.

The circuit represented in FIG. 8 comprises, in its right part, the PTAT current generator of FIG. 1, and in its left part the compensation circuit whose function is to inject into the emitter of the transistor T1 and into the emitter of the transistor T2 a current equal to the base current Ib which flows through these transistors when the current I2 proportional to the absolute temperature flows through the resistor R2. By injecting these currents, matters are contrived such that the equal currents which pass through Q1 and Q2 and therefore the current I2 which passes through the resistor R2 are not the emitter current of the transistors T1 and T2 but are the collector current Ic. When it is the emitter current, there are inaccuracies since the operating equations for the PTAT generator are based on calculating the collector currents of the transistors T1 and T2 of different size. This is of no importance when the current gain is high since the difference between collector current and emitter current is insignificant. This is of more importance when the gain is low. With the compensation introduced, the PTAT generator is really operated on the basis of collector currents even if the gain is low.

To achieve this result, the current I2 in Q1 is copied over into a branch Q10, T10. The transistor Q10 is identical to Q1 and has its gate and its source at the same potentials as the gate and the source of Q1. The transistor T10 is identical to T1 and has its emitter grounded like T1. The base of T10 is however not connected directly to ground like that of T1, it is connected to ground by way of a diode-mounted NMOS transistor Q11. A current Ib which is the base current of T10, identical to the base current of T1, therefore flows through this transistor Q11.

The current in Q11 is copied over identically into a branch with two transistors Q12 (NMOS), Q13 (diode-mounted PMOS); from there, this current Ib is further copied over
identically by a transistor Q14 which injects its current equal to Ib into the junction point between the transistors Q1 and T1.
Identically by a transistor Q15 which injects a current Ib into the junction point between the transistors Q2 and T2.

Finally, a transistor Q16 copies over the current Ib of the transistor Q13 so as to inject it at the junction point of the transistors Q10 and T10.

It follows from this that the current I2 in the transistors Q1 and Q2 is indeed a collector current of the transistors T1 and T2.

This layout results in operation where the current proportional to temperature is a transistor collector current and not an emitter current as in the conventional layouts, so that it is insensitive to the fact that the current gain of the PNP transistors is low and dispersed. It would moreover be possible to make a layout on the same principle if the transistors were NPN.

This compensation of current gain of the PMOS transistors of the PTAT generator can be applied to a more complex voltage reference circuit in which it is sought to compensate for the curvatures of the variation in reference voltage as a function of temperature near the highest or the lowest temperatures.

The layouts which will now be described use PTAT generators which are represented in a simplified form, that is to say without the base current compensation represented in FIG. 8 so as not to overburden the representation, but it will be understood that these PTAT generators are in practice embodied as in FIG. 8. However, it should be noted that the layouts which will be described can also be used with PTAT generators which do not incorporate the base current compensation of FIG. 8, since they in themselves make it possible to improve the stability of the reference voltage near high temperatures and low temperatures.

FIG. 4 represents the principle of the obtaining of a stable reference voltage. In this layout a bandgap core circuit CG such as that of FIG. 2 or FIG. 3 is used, that is to say one which uses the summation of a voltage Vbe and of a voltage proportional to the absolute temperature and giving a first-order temperature-stable reference voltage (or current); and two other voltages are added to the sum EG(T) thus obtained, one of which, denoted E2(T), arises from a circuit C2 termed a “thermometer circuit” and the other, denoted E3(T), arises from a squaring circuit C3 which squares a voltage arising from the thermometer circuit. The expression “thermometer circuit” is understood to mean a circuit that can establish a voltage proportional to the difference T−Tr between the absolute temperature T and a reference temperature Tr; the temperature Tr can be the standard ambient temperature of 25° C. The squaring circuit is, for its part, capable of establishing a voltage proportional to (T−Tr)² on the basis of a voltage provided by the thermometer circuit.

A summator ADD performs a linear combination of the three voltages EG(T), E2(T) and E3(T), that is to say it adds them together, with respective weighting coefficients G1, G2, G3, to establish an output voltage Vref=G1.EG(T)+G2.E2(T)+G3.E3(T).

The weighting coefficients are chosen such that the output voltage of the summator is rendered as constant as possible in the presence of temperature variations. The coefficient G1 can be chosen arbitrarily equal to 1, adjustment parameters such as the value of R6 making it possible to adjust the level of EG(T).

For the circuit C1, which is a basic circuit of bandgap type, it was noted that the output voltage can be considered to be overall of the form:

EG(T)=EG(Tr)+a.(T−Tr)+b.(T−Tr)²

This means that the output voltage of the circuit C1 is not constant with temperature but tends to vary according to a curve that may be approximated by a parabola.

The coefficients a and b can be determined experimentally and depend on the layout used and on the technology. EG(Tr) is a fixed value, which is the theoretical value that should hold at all temperatures but that in reality holds only at the reference temperature Tr.

The thermometer circuit C2 and the squaring circuit C3 are intended to compensate for these variations in the output voltage of the circuit CG. The thermometer circuit will have to produce a voltage E2(T)=k2.(T−Tr) intended to compensate for the term a.(T−Tr) and the squaring circuit will have to produce a voltage E3(T)=k3.(T−Tr)² intended to compensate for the term b.(T−Tr)². The coefficients G2 and G3 of the linear combination EG(T)+G1.E2(T)+G3.E3(T) performed by the summator ADD will have to be adjusted so that k2.G2=−a and k3.G3=−b in such a manner that the weighted summation of the output voltages of the three circuits C1, C2, C3 results in a voltage Vref=EG(Tr) that is as independent as possible of the temperature T.

If the circuit C1 provides an output current rather than a voltage EG(T), this current is converted into voltage in a resistor of the summator ADD. The same goes for the outputs of the circuits C2 and C3.

The coefficients G2 and G3 are negative if a, b, k1 and k2 are positive. But provision must notably be made for it to be possible for the signs of a and b to be arbitrary, and matters will be contrived so as to provide for the possibility that the coefficients G2 and G3 can be of negative sign (or alternatively that the outputs E2(T) and E3(T) can have an inverted sign if necessary).

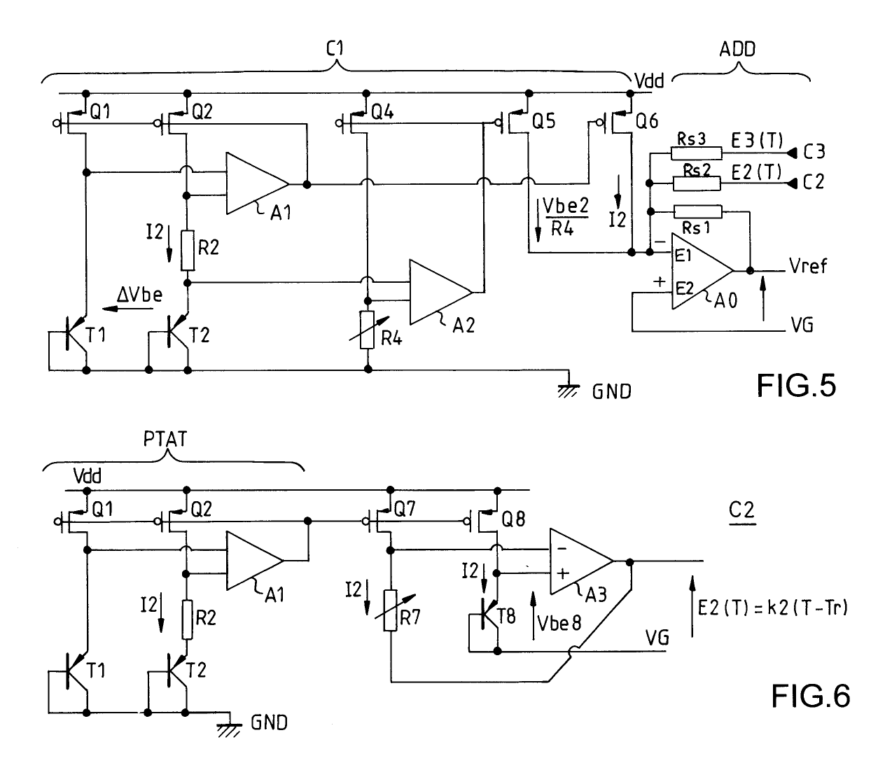

FIG. 5 is a practical layout employing the core of the bandgap circuit of FIG. 3 and showing how it is possible to perform the desired linear combination with the aid of an operational amplifier and of several summation resistors. In the case which is represented, the circuit C1 provides an output current which is the sum of the currents flowing in the transistors Q5 and Q6: (kT/q)(Log N)/R2+Vbe2/R4.

The joined outputs of the transistors Q5 and Q6, constituting the output of the circuit C1, are not applied to a resistor R6 as in FIG. 3 but they are applied, which amounts to the same, to an input E1 of an operational amplifier AO looped back through a looping resistor Rs1.

The other input E2 of the amplifier is brought to a reference potential VG (which may be ground GND or preferably the midpoint between the low power supply GND and the high power supply Vdd). The potential VG is, as will be seen, the reference with respect to which the thermometer circuit C2 provides a voltage proportional to T−Tr, and the circuit C3 provides a voltage proportional to the square of T−Tr. This is why this potential must also serve as reference in the summator ADD placed at the output of the circuit C1.

The looping resistor Rs1 converts the current which passes through it into voltage (like the resistor R6 of FIG. 3). The current which passes through it is such that the sum of the currents which enters at node E1 is zero. This sum comprises the currents arising from the transistors Q5 and Q6 (currents Vbe2/R4 and 12), the current in the resistor Rs1 and two currents injected, through a resistor Rs2 and a resistor Rs3 respectively, by the voltage-like outputs of the thermometer circuit C2 and of the squaring circuit C3.

The resistor Rs2 defines the weighting coefficient G2 corresponding to the circuit C2. This resistor Rs2 is placed between the output of the circuit C2 and the input E1 of the operational amplifier AO. Likewise, a third resistor Rs3, placed between the output of the circuit C3 and the input E1, defines the weighting coefficient G3. The circuits C2 and C3 provide voltages at low output impedance and impose their output potential on the resistors Rs2 and Rs3.

The circuits C2 and C3 provide voltages referenced with respect to the voltage VG. The circuit C2 provides a voltage E2(T) which is equal to k2.(T−Tr). The circuit C3 provides a voltage E3(T) which is equal to k3.(T−Tr)².

The operational amplifier operates in a conventional manner: the sum of the currents which arrive at its input E1 is zero, and the voltage on this input is equal to the voltage on the input E2, that is to say to VG.

If Vref denotes the output voltage (referenced with respect to the reference potential VG) of the amplifier AO, then it is possible to write:

Vref/Rs1+E2(T)/Rs2+E3(T)/Rs3+Vbe2/R4+I2=0

Vref=−Rs1[I2+Vbe2/R4]−E2(T)Rs1/Rs2−E3(T)Rs1/Rs3

Therefore

Vref=−Rs1[I2+Vbe/4]−E2(T)Rs1/Rs2−E3(T)Rs1/Rs3

Or, if EG(T) denotes the value −Rs1[I2+Vbe2/R4], the imperfect voltage of the bandgap circuit CG, equal to EG(Tr) at the reference temperature Tr:

Vref=EG(T)−k2(T−Tr)Rs1/Rs2−k3(T−Tr)²Rs1/Rs3

Since the second-order approximation has been made that EG(T) may be likened to the sum EG(Tr)+a.(T−Tr)+b(T−Tr)², it is found that

Vref=EG(Tr)+a.(T−Tr)+b(T−Tr)²−k2(T−Tr)Rs1/Rs2−k3(T−Tr)²Rs1/Rs3

Or

Vref=EG(Tr)+[a.k2.Rs1/Rs2].(T−Tr)+[b−k3Rs1/Rs3].(T−Tr)²

The value of Rs1 is in principle adjusted as a function of the value that one wishes the reference voltage Vref to have at the reference temperature Tr. This value is -Rs1[12+Vbe2/R4] measured at the reference temperature and which is EG(Tr) according to the notation used previously.

If the coefficients k2 and k3 of the circuits C2 and C3 are not adjustable, then the ratio Rs1/Rs2 is adjusted such that Rs2/Rs1=k2/a and the ratio Rs3/Rs1 is adjusted such that Rs3/Rs1=k3/b, thereby making it possible to eliminate the weighting coefficients of the terms T−Tr and (T−Tr)² and to end up with a reference voltage which has the value EG(Tr) over the whole of the temperature span for which the approximation EG(T)=EG(Tr)+a(T−Tr)+b(T−Tr)² remains valid for the bandgap circuit C1 used.

Thermometer Circuit

The thermometer circuit c2 can be constituted for example in the following manner, as represented in FIG. 6: it comprises a generator of current proportional to absolute temperature (PTAT); this generator can be the one which serves in the circuit C1 to establish the current or the voltage constant to first order. It is therefore composed of the PNP transistors T1, T2, of the differential amplifier A1, of the resistor R2, and of the current sources consisting of the PMOS transistors Q1, Q2 whose gates are linked to the output of the differential amplifier A1.

The current I2 proportional to the absolute temperature is copied over by a PMOS transistor Q7 and by a PMOS transistor Q8 which both have the same source potential and gate potential as Q1 and Q2. The transistor Q7 supplies a resistor R7. The resistor R7 is linked between the drain of the transistor Q7 and the output of a differential amplifier A3. The transistor Q8 supplies a diode-mounted bipolar transistor T8 having its emitter linked to the drain of Q8 and its collector and its base linked to the reference potential VG. The differential amplifier A3 has a first input linked to the junction point of R7 and Q7 and a second input linked to the junction point of Q8 and T8.

It follows from this that the differential amplifier A3 establishes a voltage which is the difference between the base-emitter voltage of this bipolar transistor (traversed by a current proportional to temperature) and of the voltage drop across the terminals of the resistor (traversed by a current proportional to temperature).

It can be shown and verified experimentally that if the resistor R7 is adjusted so that the output voltage of the differential amplifier A3 is equal to VG for the reference temperature Tr, then the output voltage of the amplifier for an arbitrary absolute temperature T is a voltage E2(T) practically proportional to T−Tr and that it is therefore possible to write E2(T)=k2.(T−Tr).

This near-proportionality results notably from the curve of variation practically in (T−Tr) of the base-emitter voltage Vbe8 of the transistor T8 when it is traversed by a current I2 proportional to absolute temperature.

The resistor R7 can be tailored to adjust the thermometer circuit in such a manner that the output voltage E2(T) is zero for the reference temperature Tr, that is to say in such a manner that the output of the amplifier A3 is equal to VG for this temperature.

If it is considered that the coefficient a of the curve for the variation of EG(T) with temperature can be either positive or negative, provision may be made for an additional operational amplifier, mounted as an analog inverter, at the output of the amplifier A3. The output of the additional amplifier or the output of the amplifier A3 will be used depending on the sign of a, the choice being made during the testing of the circuit; the adjustment of the resistor R7 is also done during testing.

Squaring Circuit

To produce a signal proportional to (T−Tr)² the thermometer circuit is used, and its output voltage E2(T) is applied to a squaring circuit which uses the same potential reference VG.

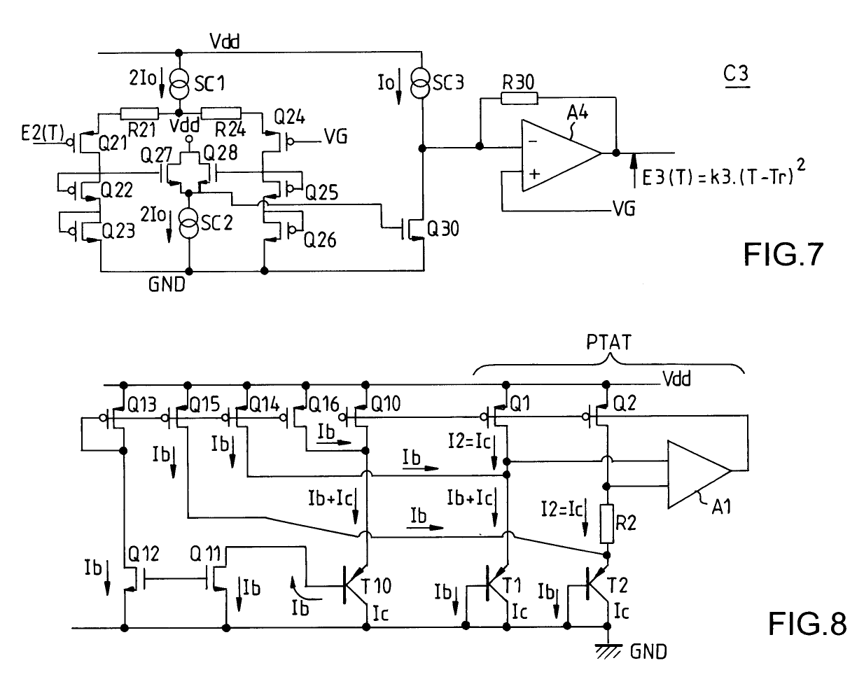

The squaring circuit can be that of FIG. 7. It comprises two current sources, incoming and outgoing, SC1 and SC2, each of arbitrary value 2.Io; the first source, SC1, supplies incoming current to a group of two identical differential branches each having a resistor and three transistors (a resistor R21, a PMOS Q21 and two NMOSs Q22 and Q23, all in series in the first branch, a resistor R24=R21, a PMOS Q24 and two NMOSs Q25 and Q26 in series in the second branch); the second source SC2 supplies outgoing current to a pair of two identical NMOS transistors Q27 and Q28 having their sources joined. These joined sources are linked to the gate of an NMOS transistor Q30 supplied by an incoming current source SC3 of value (therefore half the value of each of the other sources). The PMOS transistors of the two identical differential branches receive respectively on their gate a potential E2(T) arising from the thermometer circuit and the reference potential VG. It can be shown that the current which flows through the transistor Q30 is equal to Io+[E2(T)]²/4(R21)².Io.

A current equal to the difference between the current of the source SC3 and the current of the transistor Q30 is extracted from the junction point between the source SC3 of value Io and the drain of the transistor Q30. This difference is equal to [E2(T)]²/4.(R21)².Io.

It is converted into voltage in a differential amplifier A4, one input of which is brought to the reference voltage VG and whose other input, which receives the current [E2(T)]²/4.(R21)².Io, is linked by a loopback resistor R30 to the output of the amplifier.

The voltage which appears at the output of the amplifier is then a voltage E3(T) equal to R30.[E2(T)]²/4.(R21)².Io+VG.

The voltage E3(T) is practically proportional to the square of E2(T) and therefore to the square of T−Tr, on condition, however, that Io is almost independent of temperature. To obtain this result, matters are arranged so as to produce the current sources of value Io and 2Io on the basis of the ratio of a voltage which is almost independent of temperature to a polarization resistance Rpol. The voltage which is almost independent of temperature is preferably the output voltage EG from the bandgap circuit core.

Io is then of the form Io=Eg/Rpol and it may be noted that the voltage E3(T) then involves a ratio Rpol.R30/(R21)². This ratio is likewise almost independent of temperature, all the resistors varying in the same manner.

Here again, if the coefficient b of the curve of variation EG(T) has an arbitrary sign, it is possible to place an inverting operational amplifier at the output of the amplifier A4. The output of one or the other of these amplifiers will be chosen in the test.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A voltage reference circuit, comprising a first circuit of bandgap type providing a first-order temperature-stable voltage or current, on the basis of a PTAT current generator providing a current proportional to absolute temperature, this generator comprising,
between a power supply and a ground, two parallel branches, one having a first MOS transistor in series with a first, diode-mounted, bipolar transistor, the other comprising having a second MOS transistor identical to the first MOS transistor, a resistor and a second bipolar transistor having an emitter area N times as large as the emitter area of the first bipolar transistor, with a differential amplifier which controls the MOS transistors and which establishes in the resistor a voltage drop equal to the difference of the base-emitter voltages of the two bipolar transistors, wherein there are provided means for injecting, at the junction point between the first bipolar transistor and the first MOS transistor, a current which is equal to the base current of the first bipolar transistor and means for injecting, at the junction point of the second bipolar transistor and of the second MOS transistor, a current which is equal to the base current of the second bipolar transistor , in such a manner that the output current of the generator of current proportional to temperature is equal to the collector current and not to the emitter current of a bipolar transistor.

2. The reference circuit as claimed in claim 1, wherein the first circuit of bandgap type provides a temperature-stable voltage or current on the basis
of a bipolar transistor base-emitter voltage having a negative slope of variation as a function of temperature
and of the current arising from the PTAT generator.

3. The reference circuit as claimed in claim 2, wherein the first circuit of bandgap type comprises a generator of current proportional to absolute temperature and means for producing a current which is the ratio of a bipolar transistor base-emitter voltage to a resistance value R2, this current being applied to an input of an operational amplifier.

4. The circuit as claimed in claim 3, comprising a differential amplifier and a third MOS transistor controlled by this differential amplifier, for establishing in a resistor of value R4 a current equal to Vbe2/R4, where Vbe2 is the base-emitter voltage of the second bipolar transistor.

5. The circuit as claimed in claim 4, comprising at least one fourth and one fifth transistor for copying over the current in the resistor of value R4 and the current in the resistor of value R2.

6. The reference circuit as claimed in claim 1, comprising a summator for establishing a linear combination, with respective weighting coefficients, of three values which are respectively
the output voltage or current (EG(T)) of the first circuit of bandgap type,
the output voltage or current of a second circuit providing a voltage (E2(T)) or a current proportional to the difference between the absolute temperature T and a reference temperature Tr,
the output voltage or current (E3(T)) of a third circuit providing a voltage or a current proportional to the square of this difference.

7. The circuit as claimed in claim 6, wherein said second circuit providing a voltage proportional to the difference (T−Tr) comprises a generator of current proportional to absolute temperature, means for applying this current to a resistor of value R7 and to a bipolar transistor, and a differential amplifier for establishing a voltage which is the difference between the base-emitter voltage of this bipolar transistor and of the voltage drop across the terminals of the resistor.

8. The reference circuit as claimed in claim 2, comprising a summator for establishing a linear combination, with respective weighting coefficients, of three values which are respectively
the output voltage or current (EG(T)) of the first circuit of bandgap type,
the output voltage or current of a second circuit providing a voltage (E2(T)) or a current proportional to the difference between the absolute temperature T and a reference temperature Tr,
the output voltage or current (E3(T)) of a third circuit providing a voltage or a current proportional to the square of this difference.

9. The reference circuit as claimed in claim 3, comprising a summator for establishing a linear combination, with respective weighting coefficients, of three values which are respectively
the output voltage or current (EG(T)) of the first circuit of bandgap type,
the output voltage or current of a second circuit providing a voltage (E2(T)) or a current proportional to the difference between the absolute temperature T and a reference temperature Tr,
the output voltage or current (E3(T)) of a third circuit providing a voltage or a current proportional to the square of this difference.

10. The reference circuit as claimed in claim 4, comprising a summator for establishing a linear combination, with respective weighting coefficients, of three values which are respectively
the output voltage or current (EG(T)) of the first circuit of bandgap type,
the output voltage or current of a second circuit providing a voltage (E2(T)) or a current proportional to the difference between the absolute temperature T and a reference temperature Tr,
the output voltage or current (E3(T)) of a third circuit providing a voltage or a current proportional to the square of this difference.

11. The reference circuit as claimed in claim 5, comprising a summator for establishing a linear combination, with respective weighting coefficients, of three values which are respectively
the output voltage or current (EG(T)) of the first circuit of bandgap type,
the output voltage or current of a second circuit providing a voltage (E2(T)) or a current proportional to the difference between the absolute temperature T and a reference temperature Tr,
the output voltage or current (E3(T)) of a third circuit providing a voltage or a current proportional to the square of this difference.
